(19) United States
(12) Patent Application Publication
(10) Pub. No.: US 2007/0169086 A1
(43) Pub. Date: Jul. 19, 2007

(54) System and method for updating in-system program

(75) Inventors: Chin-Wei Cheng, Hsinchu (TW); Wen-Chung Chang, Hsinchu City (TW)

Correspondence Address: BIRCH STEWART KOLASCH & BIRCH, PO BOX 747, FALLS CHURCH, VA, 22040-0747, US

(73) Assignee: SILICONMOTION INC.

(21) Appl. No.: 11/320,600

(22) Filed: Dec. 30, 2005

(51) Int. Cl. G06F 9/44

(52) U.S. Cl. 717/168

(57) ABSTRACT

A system for updating In-System Program (ISP) comprises an ISP loader that is called when an Interrupt Function Table is matched, an ISP RAM space has run out, or a page fault has happened. When an Interrupt Function Table is matched, a Function is partially updated; when an ISP RAM space has run out, a Function is executed; and when a page fault has happened, the page fault address is recorded and the page fault is corrected.

### BACKGROUND

1. Field of Invention

The present invention relates to a system for updating In-System Program (ISP). More particularly, the present invention relates to the system for economizing the space used by the ISP.

2. Description of Related Art

FIG. 1 is a block diagram of a conventional flash controller system. As shown, a flash controller 110 comprises a microcontroller 112, RAM 114 and ROM 116, and is connected to a flash 118.

A programmer can directly program ISP on a blank programmable logic device mounted to a circuit board without unloading the device from the circuit board. Also, ISP that is previously programmed on the device can be erased and reprogrammed without unloading the device from the circuit board.

In order to perform ISP operations, the microcontroller is powered up in a special “ISP mode”. ISP mode allows the microcontroller to communicate with an external host device, such as a computer, through the serial port. The microcontroller receives commands and data from the host to erase or reprogram code.

In currently developed applications, In-System Program is becoming more widely desired. However, because the current ISP systems require massive RAM space, they are not easily applied in actual practice. Increasing RAM space is expensive and not feasible.

Moreover, as In-System Program becomes more complicated with more complex applications, page faults more frequently arise in ISP RAM which cannot be resolved by the conventional method for updating ISP.

For the foregoing reasons, there is a need for an improved system for updating ISP that can economize the space of RAM required for storing ISP, handle an event of the RAM space for storing ISP runs out, and correct page faults arising in ISP RAM.

### SUMMARY

The present invention is directed to a system for updating an ISP capable of partially replacing Functions, in order to economize the space of RAM required for storing the ISP.

It is therefore an objective of the present invention to provide a system for updating an ISP to handle an event when the space of RAM for storing the ISP has run out.

It is another objective of the present invention to provide a system for updating an ISP to correct page faults arising in ISP RAM.

It is a further objective of the present invention to provide a system for updating an ISP, comprising an ISP Loader for loading the ISP from a Flash to a RAM Buffer and an interrupt table, wherein the ISP Loader is called to update only part of a Function if the ISP is determined to match an address of the Interrupt Function Table while executing a step for comparing with the Interrupt Function Table.

It is a further objective of the present invention to provide a system for updating an ISP, comprising an ISP Loader that loads an ISP from a Flash to a RAM Buffer, wherein the ISP Loader is called to continue executing a Function if an ISP RAM is determined have run out while executing a step for determining the space of the ISP RAM.

It is a further objective of the present invention to provide a system for updating an ISP, comprising an ISP Loader that loads the ISP from a Flash to a RAM Buffer, wherein the ISP Loader is called to correct a page fault if the page fault is determined to have arisen while executing a step for determining the page fault.

It is a further objective of the present invention to provide a method for updating an ISP, comprising a step for detecting existence of a Flash, a step for detecting an ISP block to be updated if the Flash is detected to exist, a step for loading the ISP block into a RAM being an ISP RAM sequentially if the ISP to be updated exists in the Flash, a step for setting an existing flag of the ISP, a step for executing the main initial program of ROM, a step for determining the existence of an ISP flag, a step for executing the ISP, wherein the executing process jumps to an address marked in the ISP RAM and executes the ISP if the ISP flag is determined to exist, a step for determining whether a next ISP block is called, and a step for swapping an ISP from the Flash into the ISP RAM if the next ISP block is determined to exist.

It is a further objective of the present invention to provide a method for updating an ISP, comprising a step for executing ROM code, a step for comparing the ISP with an Interrupt Function Table to determine whether an address of the ISP matches the Interrupt Function Table, a step for calling an ISP Loader if the ISP is determined to match the address of the Interrupt Function Table, and a step for executing a Function.

It is a further objective of the present invention to provide a method for updating an ISP, comprising a step for executing ROM code, a step for determining whether a page fault arises in a RAM buffer, a step for calling an ISP Loader if a page fault arises in the RAM buffer, and a step for executing a Function.

It is a further objective of the present invention to provide a method for updating an ISP, comprising a step for executing ROM code, a step for determining whether a page fault arises in a space of a RAM, a step for calling an ISP Loader if a page fault arises in the space of the RAM, and a step for executing a Function.

In summary, the present invention has advantages of economizing the space of RAM required for storing ISP, handling an event when the space of RAM for storing ISP has run out, and correcting page faults arising in ISP RAM.

It is to be understood that both the foregoing general description and the following detailed description are by examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 is a block diagram of a conventional flash controller system;

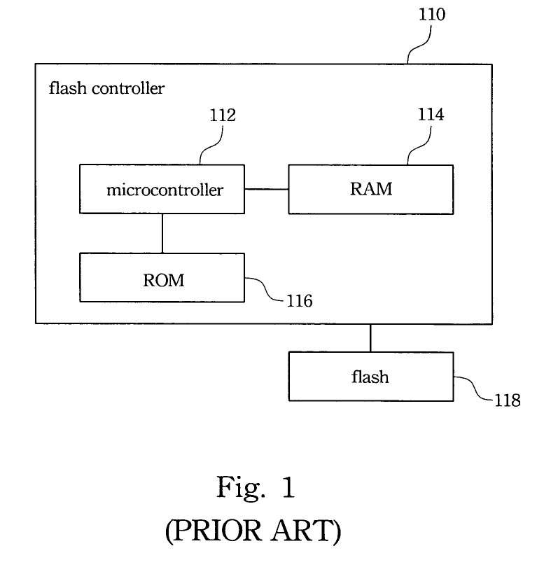

FIG. 2 is a flow chart of a method for updating ISP according to a preferred embodiment of the present invention;

FIG. 3 is a flow chart of a method for updating ISP according to another preferred embodiment of the present invention;

FIG. 4 is a flow chart of a method for updating ISP according to a further preferred embodiment of the present invention;

FIG. 5 is a flow chart of a method for updating ISP according to a further preferred embodiment of the present invention;

FIG. 6 is a block diagram of a method for updating ISP according to a further preferred embodiment of the present invention; and

FIGS. 7A and 7B are block diagrams showing flash controller systems for deploying preferred embodiments of the present invention.

### DESCRIPTION OF THE PREFERRED EMBODIMENTS

In a method for updating ISP according to a preferred embodiment of the present invention, a map file is produced from a main program project by a compiler, an assembler or a linker, and then the map file is analyzed by a public symbol parser to become a file named “ROM.INC,” which is provided for being [INCLUDE]d by an ISP project. If a program of ISP wants to call a subprogram of a mask ROM, an address of the subprogram can be obtained from information of a public symbol of the ROM.INC file. Moreover, an entry point is left in the mask ROM, and the program of the mask ROM detects whether an ISP exists in a Flash after the system is booted. If there is no ISP existing in the Flash, all subsequent programs are executed in the mask ROM. If there is an ISP existing in the Flash, the executing process jumps to the ISP RAM to execute all subsequent programs there, and a main loop of the ISP RAM replaces the main program of the mask ROM. Therefore, the program desired to be replaced can be replaced by the new program written in the ISP RAM.

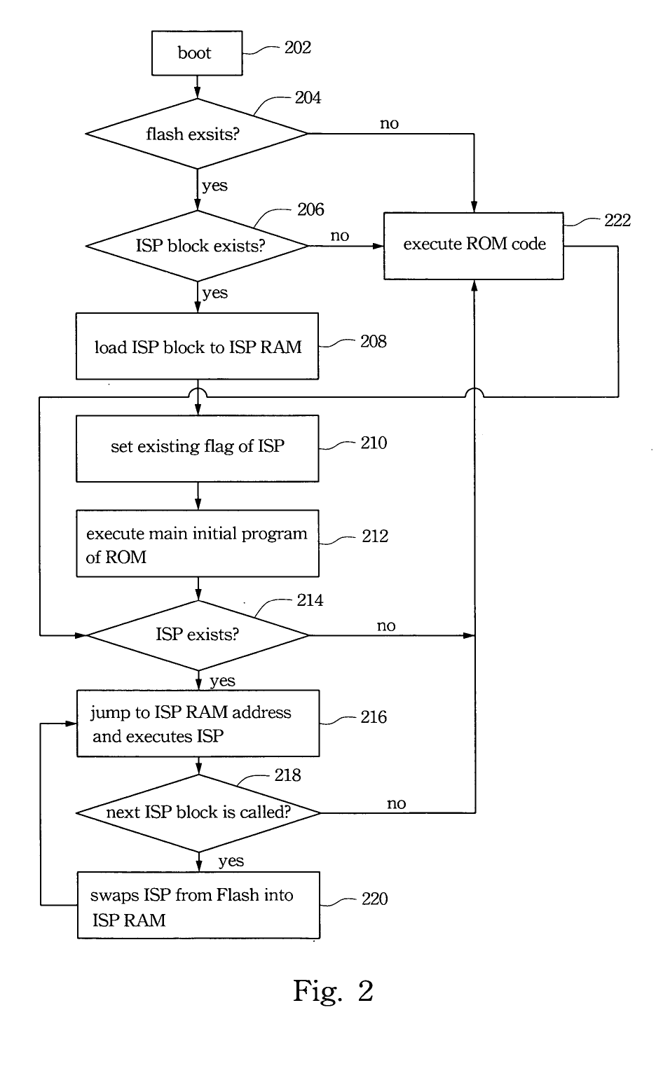

FIG. 2 is a flow chart of a method for updating ISP according to a preferred embodiment of the present invention. When an ISP needs to be updated, as shown, after a system is booted (Step 202), the system detects the existence of a Flash (Step 204). If the Flash is detected, the system detects an ISP block to be updated (Step 206). Further, if the ISP to be updated exists in the Flash, the system loads the ISP block sequentially into a RAM as ISP RAM (Step 208) and sets an existing flag of the ISP (Step 210). Then, the system executes the main initial program of ROM (Step 212) and determines the existence of an ISP flag (Step 214).

If the ISP flag is determined to exist, the executing process jumps to an address marked in the ISP RAM and executes the ISP (Step 216). The system determines whether a next ISP block is called (Step 218). If the next ISP block is determined to exist, the system swaps an ISP from the Flash into the ISP RAM (Step 220). Then, the executing process repeats the execution of the above-mentioned steps 216 to 220 until the system determines that no program of the next ISP block is called. After no program of the next ISP is called, the system carries on the execution of ROM code (Step 222).

In the above-mentioned method, if an ISP is detected in a mask ROM, a variable is set to indicate existence of the ISP, i.e., an existing flag of the ISP. Moreover, the manner to call a program can be replaced by using a Function Table. If there is any Function required to be replaced in the Function Table, it is replaced by a new program in an ISP RAM. If a program to be modified or replaced has no entry point left thereof, an entry point over the upper layer of the program can be found and all of the program under the entry point can be replaced. To take the ISP RAM as a data RAM, the instructions MOVX and MOVC of a microcontroller have to be modified and a software program is required to being programmed as a map file function parser.

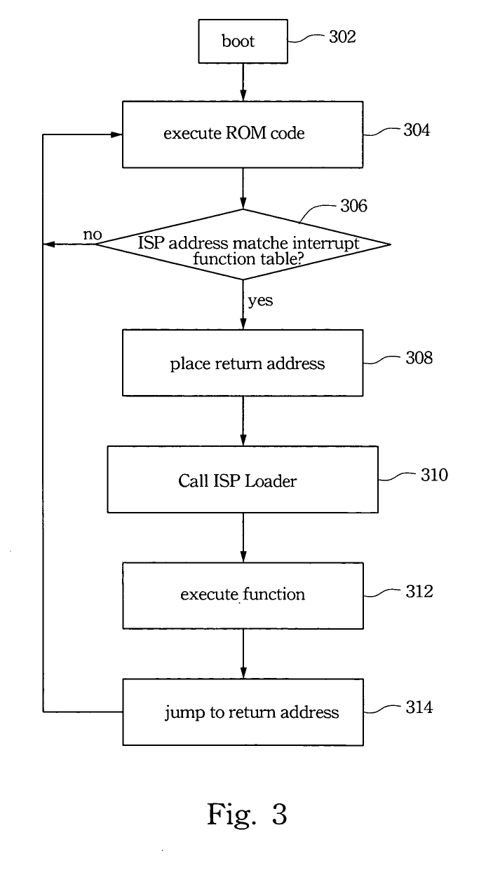

FIG. 3 is a flow chart of a method for updating ISP according to another preferred embodiment of the present invention.

After a system is booted (Step 302), the system executes a ROM code (Step 304) and compares an ISP with an Interrupt Function Table to determine whether an address of the ISP matches the Interrupt Function Table (Step 306). If the ISP is determined to match the address of the Interrupt Function Table, a return address is set (Step 308) and an ISP Loader is called (Step 310) for executing a Function (Step 312). Finally, the executing process jumps to the return address (Step 314) and then returns to Step 304 to continue executing the ROM code. The Interrupt Function Table is programmable, and thereby a programmer can choose and design the Function to be replaced.

According to the above-mentioned embodiment, the present invention can partially replace a Function and thus has the advantage of economizing the space of RAM required for storing ISP.

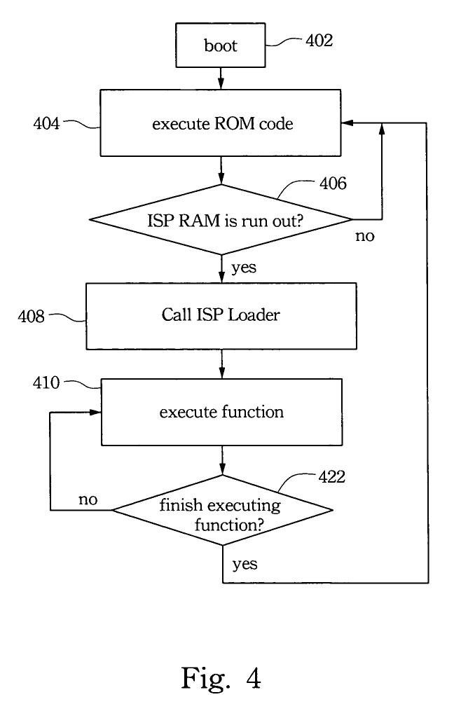

FIG. 4 is a flow chart of a method for updating ISP according to a further preferred embodiment of he present invention.

After a system is booted (Step 402), the system executes a ROM code (Step 404). The system determines whether a space of an ISP RAM has run out (Step 406). If the space of the ISP RAM is determined to have run out, an ISP Loader is called to execute a Function (Steps 408 and 410). When the execution of the Function is finished (Step 422), the executing process returns to Step 404 to continue executing the ROM code.

According to the above-mentioned embodiment, the present invention has the advantage of handling the event when the space of RAM for storing ISP has run out.

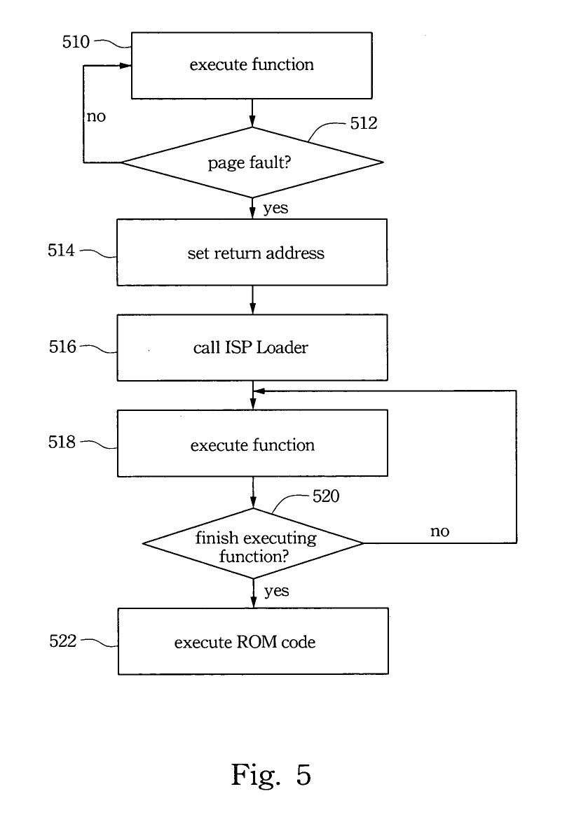

FIG. 5 is a flow chart of a method for updating ISP according to a further preferred embodiment of the present invention.

As shown, when executing a Function in Step 510, e.g., Step 312 of FIG. 3 and Step 410 of FIG. 4, a system determines whether a page fault arises in a space of a RAM (Step 512). If the page fault arises in the space of the RAM, a return address is set (Step 514) and ISP Loader is called (Step 516) to execute a Function (Step 518). After the execution of the Function is finished, a ROM code is executed (Step 522).

According to the above-mentioned embodiment, the present invention has the advantage of correcting page faults arising in the ISP RAM.

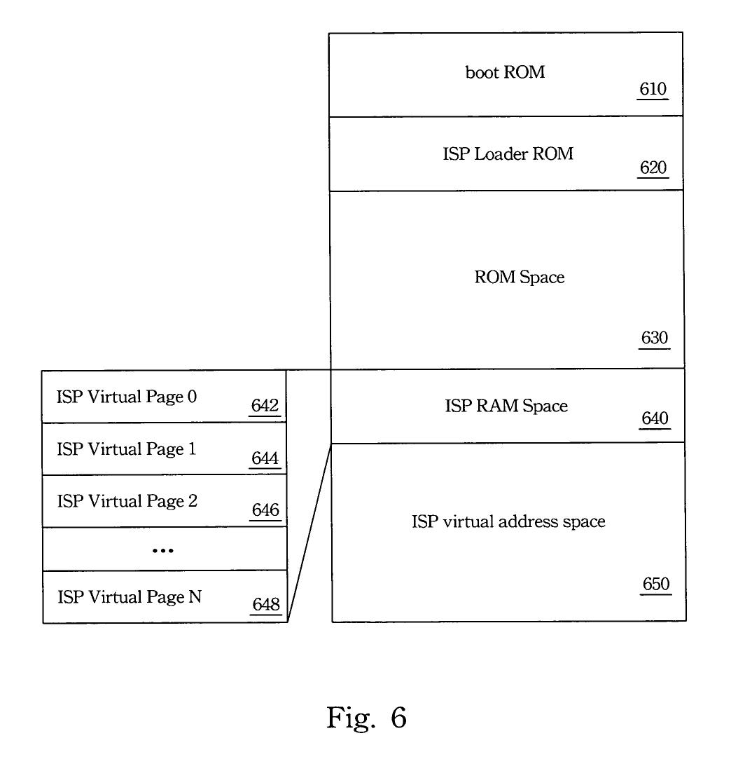

FIG. 6 is a block diagram of a method for updating ISP according to a further preferred embodiment of the present invention.

As shown, a system comprises: a boot ROM (Block 610), an ISP Loader ROM (Block 620), a ROM Space (Block 630), an ISP RAM Space (Block 640), and an ISP virtual address space (Block 650). The ISP RAM space further comprises multiple ISP virtual pages, i.e., ISP Virtual Page 0 (Block 642) to ISP Virtual Page N (Block 648).

In the system, ISP Loader ROM (Block 620) loads an ISP from a Flash to RAM Buffer for partially replacing a Function, handles when the ISP RAM space has run out, and, when a page fault arises, corrects and records the page fault address.

Moreover, the system can comprise: a Jump/Reset Table for recording the entry/exit point when a Function is executed; an ISP Loader Program Position Table for recording a position of an ISP Loader program; and a Page Map Table mapping a Function to flash for indicate a part of flash required to be loaded thereto, when the size of ROM is larger than the size of an ISP.

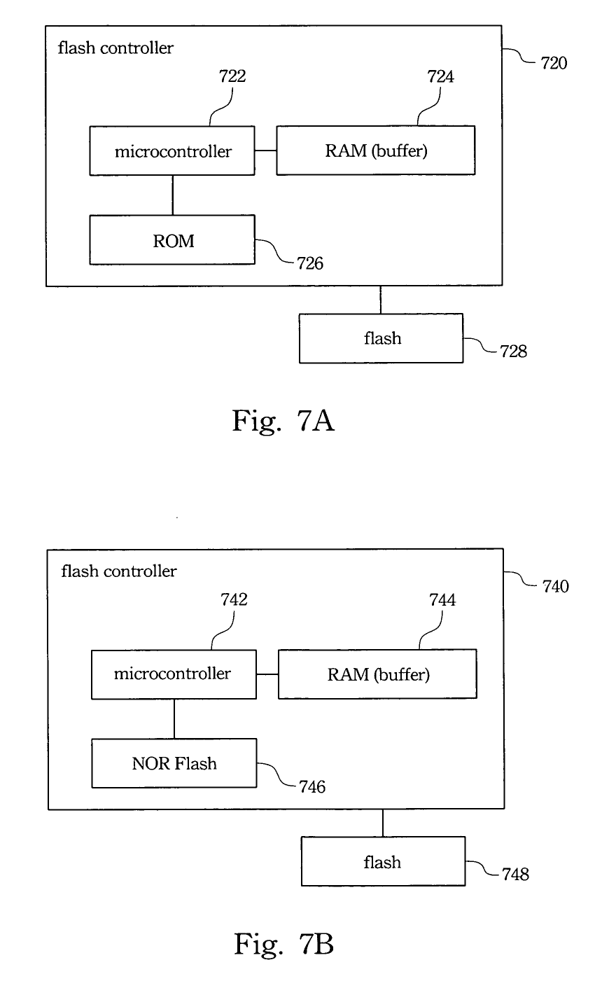

FIGS. 7A and 7B are block diagrams showing flash controller systems for deploying preferred embodiments of the present invention.

As shown, the devices of RAM (elements 724 and 744) are both used as the buffer for storing data. In the embodiment shown in FIG. 7B, ROM is replaced by NOR Flash (element 746).

According to the above-mentioned embodiments, the present invention has the advantage of economizing the space of RAM required for storing ISP, handling an event when the space of RAM for storing ISP has run out, and correcting page faults arising in ISP RAM.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for updating an ISP, comprising:
an ISP Loader for loading the ISP from a Flash to a RAM Buffer; and
an Interrupt Function Table,
wherein, the ISP Loader is called to update only part of a Function if the ISP is determined to match an address of the Interrupt Function Table while executing a step for comparing with the Interrupt Function Table.

2. The system of claim 1, wherein the step for comparing with the Interrupt Function Table further comprises a step for setting a return address used for returning to an original address after executing the Function.

3. The system of claim 1, further comprising a Jump/Reset Table for recording an entry point or an exit point when the Function is executed.

4. The system of claim 1, further comprising an ISP Loader Program Position Table for recording a position of an ISP Loader program.

5. The system of claim 1, further comprising a Page Map Table mapping the Function to the flash for indicating a part of flash required to be loaded thereto, when the size of ROM is larger than the size of an ISP.

6. The system of claim 1, wherein the ISP Loader is located at a ROM or a Flash.

7. The system of claim 1, wherein the Interrupt Function Table is programmable.

8. A system for updating an ISP, comprising:
an ISP Loader that loads an ISP from a Flash to a RAM Buffer,
wherein the ISP Loader is called to continue executing a Function if an ISP RAM is determined to have run out while executing a step for determining the space of the ISP RAM.

9. The system of claim 8, further comprising a Jump/Reset Table for recording an entry point or an exit point when the Function is executed.

10. The system of claim 8, further comprising an ISP Loader Program Position Table for recording a position of an ISP Loader program.

11. The system of claim 8, further comprising a Page Map Table mapping the Function to the flash for indicating a part of flash required to be loaded thereto, when the size of ROM is larger than the size of an ISP.

12. The system of claim 8, wherein the ISP Loader is located at a ROM or a Flash.

13. A system for updating an ISP, comprising:
an ISP Loader that loads the ISP from a Flash to a RAM Buffer,
wherein the ISP Loader is called to correct a page fault, if the page fault is determined to have arisen, while executing a step for determining the page fault.

14. The system of claim 13, wherein the step for determining the page fault further comprises a step for recording an address of the page fault.

15. The system of claim 13, wherein the step for determining the page fault further comprises a step for setting a return address used for returning to an original address after executing the Function.

16. The system of claim 13, further comprising a Jump/Reset Table for recording an entry point or an exit point when the Function is executed.

17. The system of claim 13, further comprising an ISP Loader Program Position Table for recording a position of an ISP Loader program.

18. The system of claim 13, further comprising a Page Map Table mapping the Function to the flash for indicating a part of flash required to be loaded thereto, when the size of ROM is larger than the size of an ISP.

19. The system of claim 13, wherein the ISP Loader is located at a ROM or a Flash.

20. A method for updating an ISP, comprising:
a step for detecting existence of a Flash;
a step for detecting an ISP block to be updated if the Flash is detected to exist;
a step for loading the ISP block into a RAM being an ISP RAM sequentially if the ISP to be updated exists in the Flash;
a step for setting an existing flag of the ISP;
a step for executing the main initial program of ROM;
a step for determining the existence of an ISP flag;
a step for executing the ISP, wherein the executing process jumps to an address marked in the ISP RAM and executes the ISP if the ISP flag is determined to exist;
a step for determining whether a next ISP block is called; and
a step for swapping an ISP from the Flash into the ISP RAM if the next ISP block is determined to exist.

21. A method for updating an ISP, comprising:
a step for executing ROM code;
a step for comparing the ISP with an Interrupt Function Table to determine whether an address of the ISP matches the Interrupt Function Table;
a step for calling an ISP Loader if the ISP is determined to match the address of the Interrupt Function Table; and
a step for executing a Function.

22. The method of claim 21, further comprising a step for setting a return address used for returning to an original address after executing the Function.

23. A method for updating an ISP, comprising:
a step for executing ROM code;
a step for determining whether a space of an ISP RAM has run out;
a step for calling an ISP Loader if the space of the ISP RAM is determined to have run out; and
a step for executing a Function.

24. A method for updating an ISP, comprising:
a step for executing ROM code;
a step for determining whether a page fault arises in a RAM buffer;
a step for calling an ISP Loader if the page fault is determined to have arisen in the RAM buffer; and
a step for executing a Function.

25. The method of claim 24, further comprising a step for setting a return address used for returning to an original address after executing the Function.
